(19) United States
(12) Patent Application Publication
(10) Pub. No.: US 2017/0120083 A1
(43) Pub. Date: May 4, 2017

(54) PROTECTIVE INTEGRATED HOOD FOR GARMENT

(71) Applicant: W. L. Gore & Associates, Inc., Newark, DE (US)

(72) Inventor: Peter R. Pratt, West Grove, PA (US)

(21) Appl. No.: 15/335,819

(22) Filed: Oct. 27, 2016

Related U.S. Application Data
(60) Provisional application No. 62/248,125, filed on Oct. 29, 2015.

(51) Int. Cl. A62B 17/00; A41D 27/20; A41D 13/02; A62B 17/04; A41D 3/00

(52) U.S. Cl. CPC A62B 17/006; A62B 17/04; A62B 17/001; A62B 17/003; A41D 3/00; A41D 13/02; A41D 27/201

(57) ABSTRACT

Disclosed is a protective hood for use in protection against fire, chemical and/or biological threats, and other similar harmful environments to which individuals may be exposed under a variety of extreme conditions. The hood includes a flap that is partially separable from the remainder of the hood, where the flap includes a port for receiving a protective mask. Protective garments including the hood are also disclosed.

### CROSS REFERENCE TO RELATED APPLICATIONS

This patent application claims priority from U.S. Provisional App. No. 62/248,125, entitled “Protective Integrated Hood for Garment,” filed Oct. 29, 2015, the disclosure of which are incorporated herein by reference in its entirety.

### FIELD

The field relates generally to protective hoods for garments, and more specifically to a closure system for protective hoods which can be used in a variety of potentially harmful environments such as fire, chemical and/or biological conditions.

### BACKGROUND

Current standard practice for responders to hazardous conditions is to wear a fully encapsulated suit when using protective masks and/or breathing apparatus during incidents requiring protection of the responder.

In hazardous conditions where liquid and vapor personal protection are preferred or necessary, the wearer will normally use an appropriate breathing apparatus and dress in a fully encapsulated suit, commonly referred to as a Level A ensemble design. Due to the cumbersome nature of encapsulating suits and the need to minimize the number of sealed openings, serious efforts have focused on encapsulating garment designs with hoods which could be easily and quickly donned and doffed in use.

Typically designs that separate the hood down the center by extending the main zipper path up past the neck and around the crown of the head create a problem for the user to store the front half of the hood which falls toward the frame of the body. This is both difficult to store and subject to damage due to snagging or crush punctures under load created by tactical accessories like ballistic vests, or back or front packs. In cases of conventional rainwear, the integrated hood is commonly seen as largely unobtrusive to the wearer because it falls in the large part of the back garment and can even be stored in an integrated pocket on the back of the garment adjacent to the neck. However, conventional rainwear is not configured for use in highly protective environments.

Efforts to leverage rainwear integrated hood designs into more protective uses, such as fire, chemical and biological threat garments are complicated by the frequent need to seal the garments to gas-tight levels around a gas mask, which requires the integration of some sort of conformable sealing layer at the interface of the garment and gas mask.

In the case of the rain jacket design the main zipper opening terminates in the circumference line of the hood front opening. While this makes jackets easy to put on in situations requiring protection from exposure to harmful environments, it causes difficulty in providing a seal due to the inherent discontinuity introduced at the interface region that seals to the mask surface. Designs that integrate a mask seal surface that is continuous (unbroken seal) introduce difficulties in how to create a user acceptable hood opening. The main openings tend to be horizontal across the back or front and do not provide for rapid escalation of protective posture and create large hoods that cannot be sealed easily and impact the user's ability to be effective. However, designs that do not break the conformable sealing surface at the mask interface deliver high levels of protection and can more easily achieve a gas/liquid seal.

In searching for designs to improve the comfort and ease of use by the wearer without compromising the respiratory protection, the garment design becomes a challenge.

Accordingly, a need has existed for a protective ensemble which provides appropriate levels of protection to the wearer allowing for easy and rapid donning of the hood to minimize the impact on the user's donning times when the protective ensemble is worn at low protective posture level and needs to quickly be donned to the higher protective posture level.

### SUMMARY

The terms “invention,” “the invention,” “this invention,” and “the present invention,” as used in this document, are intended to refer broadly to all of the subject matter of this patent application and the claims below. Statements containing these terms should be understood not to limit the subject matter described herein or to limit the meaning or scope of the patent claims below. Covered embodiments of the invention are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The embodiments of the present invention provide protective ensembles incorporating a hood design for use in protection against fire, chemical and/or biological threats, and other similar harmful environments to which individuals may be exposed under a variety of extreme conditions.

Embodiments of the present invention provide a protective hood including a main hood region, a flap, and at least two fasteners disposed on the main hood region and/or the flap and configured to secure the main hood region to the flap. The flap includes an outer perimeter and a port defined by an inner perimeter. The flap is fixedly secured to the main hood region along a portion of the outer perimeter. Optionally, each of the at least two fasteners are disposed partially on the main hood and partially on the flap so that the portion of each fastener engage with each other to secure the main hood region to the flap. Optionally, the fasteners are configured to removably secure the main hood region to the flap. Optionally, the at least two fasteners independently are zippers, Velcro, non-reversible adhesive, rail closures, or a combination thereof.

Optionally, the flap is integral with the main hood region at the point where the flap is fixedly secured to the main hood region. For example, the flap and the main hood region may be made of a single piece of material that remains connected at the point where the flap is fixedly secured to the main hood region.

In some embodiments, the flap includes a ring of protective material. In some embodiments, the flap includes a sealing surface on or adjacent to the protective material, wherein the sealing surface forms a ring immediately surrounding the port.

In some embodiments, the hood further includes a fastener for securing the flap when the flap is not in use. For example, the flap may be secured by snaps, Velcro, strings, or loops. Optionally, the hood may comprise a pocket for containing the flap when not in use. Optionally, the hood may include a fastener, such as one or more snaps, Velcro, strings, or loops, for closing the pocket and/or keeping the flap inside the pocket.

Other embodiments of the present invention provide a protective garment comprising a body region having leg-receiving and arm-receiving regions and a hood region including a mask-receiving port. The protective garment has an opening extending from the body region into the hood region through which the protective garment can be donned and doffed. The opening has a perimeter defined by a first fastener located at least partially in the body region, and second and third fasteners in the hood region, each fastener having an engaged configuration and a disengaged configuration. The opening also includes a junction where the first, second and third fasteners meet when each of the fasteners is engaged. The second and third fasteners are oriented relative to one another to define a flap within the hood region when the second and third fastener components are disengaged, wherein the mask-receiving port is located within the flap. The protective garment includes a securing means for securing the flap when the mask-receiving port is not in use.

In some embodiments, the second and third fasteners are configured to removably secure the flap to the remainder of the hood. Optionally, the flap is fixedly secured to the remainder of the hood region at an attachment point.

In some embodiments, the flap includes a ring of protective material and a sealing surface on or adjacent to the protective material, wherein the sealing surface forms a ring immediately surrounding the mask-receiving port.

Optionally, the first, second, and third fasteners each independently include a zipper, Velcro, a non-reversible adhesive, rail closures, or a combination thereof.

In some embodiments, the protective garment is a jacket. In other embodiments, the protective garment is a full-body suit. In still other embodiments, the protective garment is overalls.

These and other features will be described in more detail herein.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a perspective view of one embodiment of a protective hood as described herein, where the hood is not deployed (i.e., fasteners are not fully engaged).

FIG. 2 is a perspective view of one embodiment of a protective hood as described herein, wherein the hood is deployed with the fasteners fully engaged.

FIG. 3 is a perspective view of a full-body suit including a protective hood according to embodiments described herein.

FIG. 4 is a perspective view of a jacket including a protective hood according to embodiments described herein.

FIG. 5 is a perspective view of a overalls including a protective hood according to embodiments described herein.

FIG. 6 is a perspective view of a hood with a pocket for securing the flap when not in use.

FIG. 7 is a perspective view of a hood with a strap for securing the flap when not in use.

### DETAILED DESCRIPTION

The present invention provides protective ensembles incorporating a hood design for use in protection against fire, chemical and/or biological threats, and other similar harmful environments to which individuals may be exposed under a variety of extreme conditions.

The protective garments described herein provide a closure system for protective hoods that includes a hood having a main hood region and a flap that is partially separable from the main hood. The partially separable flap includes an opening, or port. In some embodiments the flap is ring-shaped with the inner perimeter of the ring defining the port. The flap is configured to receive a wearer's face (and any protective mask) through the port and to form an interface with the wearer's face and/or face mask. Optionally, the flap engages with a protective mask to form a protective seal.

In some embodiments, the flap of the hood includes a ring of protective material around the outside of the flap and a mask-sealing surface surrounding the opening, or port. The mask-sealing surface is continuous (unbroken) and is attached to the ring of protective material. Optionally, the ring of protective material is also continuous.

Optionally, the ring of protective material is fixedly attached to the main hood region at one or more attachment points around the outside perimeter of the flap. As one example, the ring may be fixedly attached to the main hood region by being formed from the same piece of material such that the flap and the hood are integral at the attachment point.

Optionally, the ring of protective material is further secured to the main hood around the outside perimeter of the ring by one or more fasteners that are positioned on either side of attachment point. Optionally, the ring is further secured to the main hood using two or more fasteners. Thus, in some embodiments, the flap includes one, two, or more fasteners that are configured to engage with fasteners on the main hood region, i.e., the remainder of the hood. When the hood is fully assembled with all fasteners fully engaged, the flap lies around a wearer's face with the mask-sealing surface of the flap, surrounding the wearer's face and any mask, and the ring of protective material surrounding the mask-sealing surface and secured to the body of the hood.

Optionally, the fasteners are positioned on either side of the attachment point. For example, the flap may be fixedly secured to the body of the hood at a point that aligns in-use with the top of a wearer's head and removably secured to the body of the hood with two fasteners positioned respectively around the left and right sides of the wearer's head extending from the top of the wearer's head to below the wearer's chin. In other embodiments, the flap may be fixedly or removably secured at any point around the outside perimeter of the flap and when the fasteners are fully engaged, the flap is secured to the body of the hood around the entire perimeter of the flap.

In some embodiments the protective hood described herein is part of a protective garment that further includes a body region attached to the hood. Optionally, the hood is integral with the body region around at least a portion of the top of the body region. For example, the garment may be a hooded jacket. Thus, in some embodiments, the protective garment includes arm receiving regions. As another example, the garment may be a hooded, full-body suit. Thus, in some embodiments, the protective garment includes arm-receiving regions and leg-receiving regions. The protective garment including a hood as described herein may be in the form of any protective garment known in the art.

In some embodiments, the flap and/or the body of the hood is further secured to the front of the body region of the garment, for example under the wearer's chin. In some embodiments, the garment has a first fastener for securing portions of the garment in the body area, for example for securing left and right sides of a jacket-type garment or of a front-opening, full-body suit. In those embodiments, the fasteners that secure the flap to the body of the hood may be second and third fasteners, and the first, second, and third fasteners may meet at a junction. Optionally, the first, second and third fasteners abut at the junction. Optionally, the first second and third fasteners overlap at the junction.

In the protective garments described herein, the hood lays toward the wearer's back when not deployed and has a relatively low profile/bulk from a quantity of material perspective. The protective garments described herein allow for a standard vertically-opened front fastener orientation for easy donning and doffing.

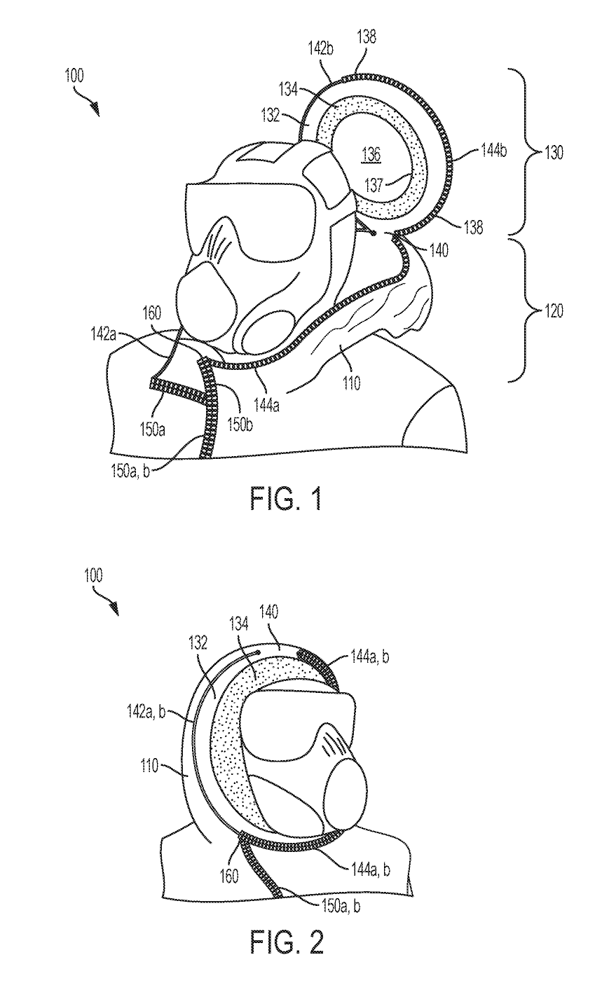

FIG. 1 is a perspective view of a person wearing a garment 100 incorporating a protective hood 110 according to embodiments described herein. FIG. 1 illustrates an embodiment including a protective hood 110 integral with a protective garment 100, where the protective hood 110 includes a main hood region 120 and a flap 130. The flap 130 includes a ring of protective material, or carrier, 132, a sealing surface 134, and a port 136. The ring of protective material 132 is fixedly attached to the main hood region 120 at an attachment point 140. The main hood region 120 includes two fastener components 142a,144a that run around opposite sides of the main hood region 120 and are configured to engage with two fasteners 142b,144b that run around the outer perimeter 138 of the flap 130. A front fastener 150a,150b of the protective garment 100 extends from a lower point (not shown) within the garment 100 and ends at an interface point 160 where the other fasteners form a butt interface or overlap interface adjacent to the interface point 160. The hood 110 extends down the wearer's back when not in use, i.e., when the fasteners 142a,b, 144a,b are not engaged.

FIG. 2 is a perspective view of a person wearing the garment 100 of FIG. 1 showing the hood in the deployed position, wherein the fasteners 142a,b, 144a,b, and 150a,b are fully engaged and meet at interface point 160 to provide a sealed hood for the wearer.

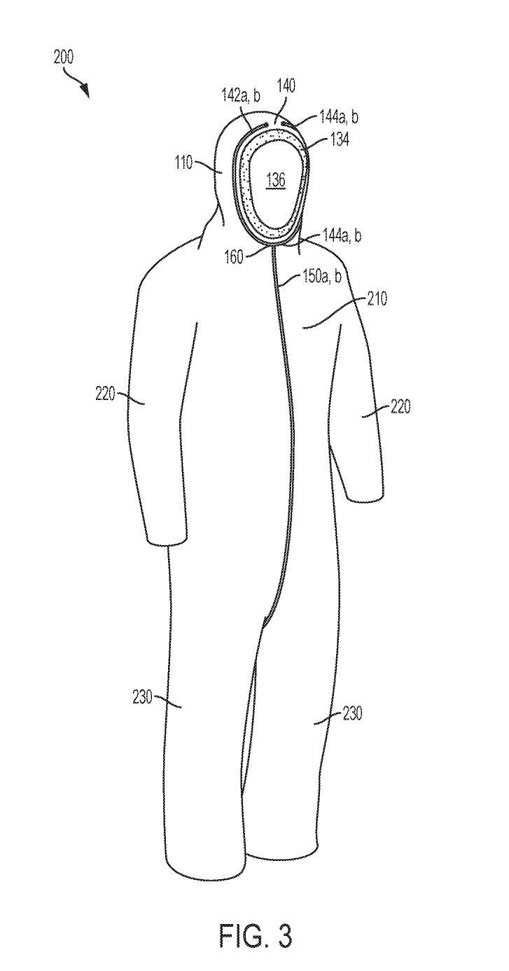

FIG. 3 is a perspective view of a garment incorporating a protective hood 110 according to embodiments described herein. FIG. 3 illustrates a full-body suit 200 including a protective hood 110 with the hood in the deployed position, wherein the fasteners 142a,b, 144a,b, and 150a,b are fully engaged and meet at interface point 160 to provide a sealed hood 100 for the wearer. The suit 200 shown in FIG. 3 includes a body region 210 having arm-receiving regions 220 and leg-receiving regions 230.

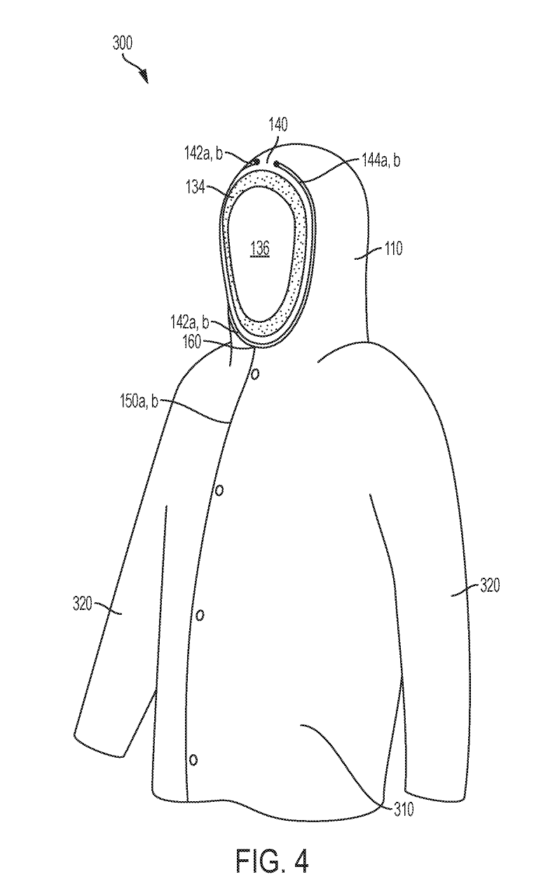

FIG. 4 is a perspective view of a garment incorporating a protective hood 110 according to embodiments described herein. FIG. 4 illustrates a protective jacket 300 including a protective hood 110 with the hood in the deployed position, wherein the fasteners 142a,b, 144a,b, and 150a,b are fully engaged and meet at interface point 160 to provide a sealed hood 100 for the wearer. The jacket 300 shown in FIG. 4 includes a body region 310 having arm-receiving regions 320.

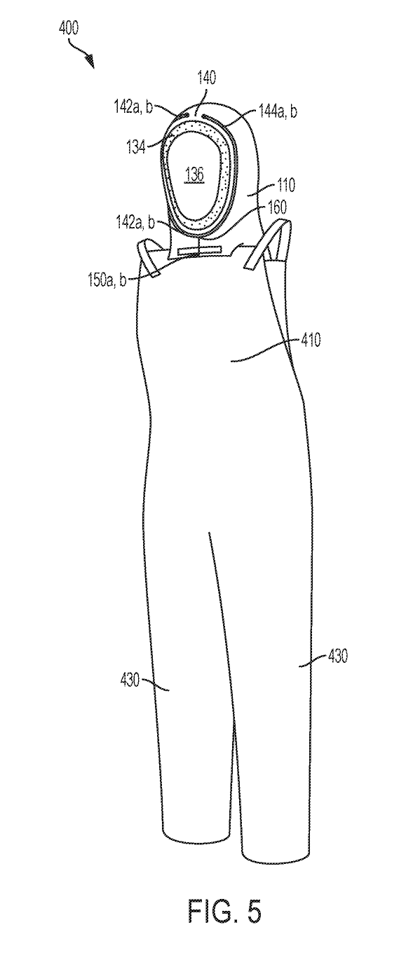

FIG. 5 is a perspective view of a garment incorporating a protective hood 110 according to embodiments described herein. FIG. 5 illustrates protective overalls 400 including a protective hood 110 with the hood in the deployed position, wherein the fasteners 142a,b, 144a,b, and 150a,b are fully engaged and meet at interface point 160 to provide a sealed hood 110 for the wearer. The overalls 400 shown in FIG. 5 include a body region 410 having leg-receiving regions 430.

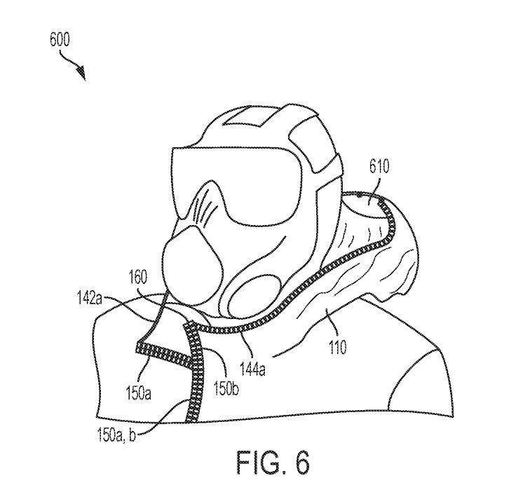

FIG. 6 is a perspective view of a hood 600 similar to that shown in FIG. 1 with a pocket 610 for securing the flap (not shown) when not in use.

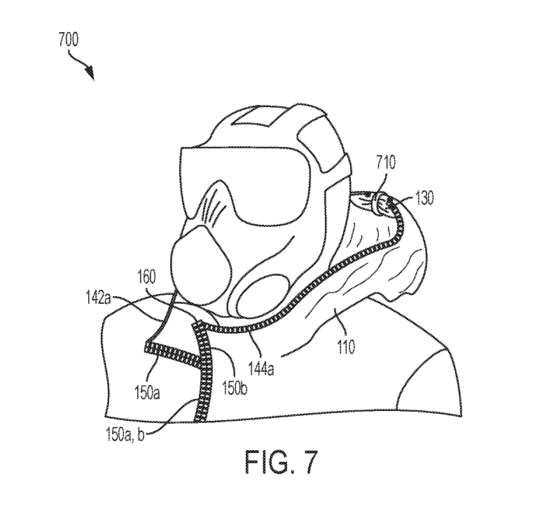

FIG. 7 is a perspective view of a hood 700 similar to that shown in FIG. 1 with a strap 710 for securing the flap 130 when not in use.

It should be appreciated that the connection of the flap region may be oriented in multiple regions around the periphery anywhere around the periphery of the hood region.

An integrated protective hood of the present invention may be tailored to withstand a variety of exposure conditions in order to provide protection to a wearer. Garments of the invention may be tailored to provide high chemical/aerosol and liquid protection with capability for rapid personal protective equipment (PPE) donning and doffing, as well as rapid transition between dressed down (hood down or off, with limited protection level) and fully protective PPE states (hood engaged and personal protection equipment fully deployed. This garment design provides the basis for novel low profile stowage of the integrated hood during dressed down PPE state which minimizes impact on wearer operational effectiveness and maintains the high protective capability of the hood when deployed during threat scenarios.

Masks which may be used in accordance with the present inventive garment construction may include respiratory masks (e.g., with a canister), chemical protective masks, filtering masks, powered air personal respirators (PAPR), self-contained breathing apparatus (SCBA), and the like.

Non-limiting examples of suitable fastener components that may be used in accordance with the present invention may include zippers, Velcro® fasteners, “non-reversible” adhesive construction, rail closures, and combinations thereof. A non-reversible adhesive construction may be used for a single use or disposal use.

Suitable securing mechanisms for securing the flap region when not in use may include snaps, Velcro® fasteners, strings/ties, loops, pockets, or the like.

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A protective hood comprising
a main hood region;
a flap comprising an outer perimeter and a port defined by an inner perimeter, wherein the flap is fixedly secured to the main hood region along a portion of the outer perimeter; and
at least two fasteners disposed on the main hood region and/or the flap and configured to secure the main hood region to the flap.

2. The protective hood of claim 1, wherein the at least two fasteners are configured to removably secure the main hood region to the flap.

3. The protective hood of claim 1, wherein at the point where the flap is fixedly secured to the main hood region, the flap and the main hood region are integral.

4. The protective hood of claim 1, wherein the flap comprises a ring of protective material.

5. The protective hood of claim 4, wherein the flap further comprises a sealing surface on or adjacent to the protective material, wherein the sealing surface forms a ring immediately surrounding the port.

6. The protective hood of claim 1, wherein the at least two fasteners each independently comprise a zipper, Velcro, a non-reversible adhesive, rail closures, or a combination thereof.

7. The protective hood of claim 1, further comprising a fastener for securing the flap when the flap is not in use.

8. The protective hood of claim 7, wherein the fastener for securing the flap comprises one or more snaps, Velcro, strings or loops.

9. The protective hood of claim 1, further comprising a pocket for securing the flap region when the flap is not in use.

10. A protective garment comprising
the protective hood of claim 1; and
a body region, wherein the body region is integral with the main hood region of the protective hood.

11. The protective garment of claim 10, wherein the body region comprises a front fastener that contacts at least one of the at least two fasteners in the hood region when the front fastener and the at least two fasteners in the hood region are engaged.

12. The protective garment of claim 10, further comprising two arm-receiving regions.

13. The protective garment of claim 10, further comprising two leg-receiving regions.

14. A protective garment comprising:
a body region comprising leg-receiving and arm-receiving regions;
a hood region comprising a mask-receiving port;
an opening extending from the body region into the hood region through which the protective garment can be donned and doffed,
wherein the opening comprises
a perimeter defined by a first fastener located at least partially in the body region, and second and third fasteners in the hood region, wherein each fastener component has an engaged configuration and a disengaged configuration and
a junction where the first, second and third fasteners meet when each of the fasteners is engaged,
wherein the second and third fasteners are oriented relative to one another to define a flap within the hood region when the second and third fastener components are disengaged, wherein the mask receiving port is located within the flap; and
a securing means for securing the flap when the mask-receiving port is not in use.

15. The protective garment of claim 14, wherein the second and third fasteners are configured to removably secure the flap to the remainder of the hood.

16. The protective hood of claim 14, wherein the flap is fixedly secured to the remainder of the hood region at an attachment point.

17. The protective hood of claim 14, wherein the flap comprises a ring of protective material and a sealing surface on or adjacent to the protective material, wherein the sealing surface forms a ring immediately surrounding the mask-receiving port.

18. The protective garment of claim 14, wherein the first, second, and third fasteners each independently comprises a zipper, Velcro, a non-reversible adhesive, rail closures, or a combination thereof.

19. The protective garment of claim 14, wherein the garment comprises a jacket.

20. The protective garment of claim 14, wherein the garment comprises a full-body suit.
